(19) United States
(12) Patent Application Publication
(10) Pub. No.: US 2018/0254996 A1
(43) Pub. Date: Sep. 6, 2018

(54) AUTOMATIC SCALING OF MICROSERVICES BASED ON PROJECTED DEMAND

(71) Applicant: International Business Machines Corporation, Armonk, NY (US)

(72) Inventors: Sudheesh S. Kairali, Kozhikode (IN); Vijay R. Kalangumvathakkal, Koodal (IN); Ayyalaraju C. Koundinya, Hyderabad (IN); Rohit S. Shetty, Cary (NC)

(21) Appl. No.: 15/448,956

(22) Filed: Mar. 3, 2017

(51) Int. Cl. H04L 12/911; H04L 12/927

(52) U.S. Cl. CPC H04L 47/788; H04L 47/803; H04L 47/823

(57) ABSTRACT

The system, method, and computer program product described herein provide automatic scaling of resources allocated to microservices based on projected demand data received from consumers of the microservices. In an aspect of the present disclosure, a method for scaling up or down a capacity allocated to a microservice is disclosed. The method includes receiving projected demand data for a microservice from a plurality of consumers, aggregating the projected demand data together, calculating a total projected demand for the microservice for a future period of time based on the aggregated projected demand data, and determining, based at least in part on the total projected demand, whether to scale up or scale down a capacity allocated to the microservice for the future period of time.

### BACKGROUND

Microservices are independent components of a software or computer system application that runs on a computer system or environment, e.g., on a computing device, a server, or other similar computing systems. Each microservice may be independently deployed, scaled, and maintained. Because each microservice may be independently deployed, the development of each microservice may be parallelized across multiple teams. Microservices are often used as plug and play components to provide new services in a cloud based environment. As demand for each microservice increases or decreases, the resources, e.g., processors, memory, bandwidth, etc., assigned to that microservice may also be increased or decreased as needed to meet the demand. This increase or decrease, sometimes called Auto Scaling, is often performed automatically in response to the increase or decrease in demand so that only the required amount of computer resource capacity, e.g., processors, memory, bandwidth, etc., is allocated to the microservice.

### BRIEF SUMMARY

The system, method, and computer program product described herein provide automatic scaling of resources allocated to microservices based on projected demand data received from consumers.

In an aspect of the present disclosure, a method for scaling up or down a capacity allocated to a microservice is disclosed. The method includes receiving projected demand data for a microservice from a plurality of consumers, aggregating the projected demand data together, calculating a total projected demand for the microservice for a future period of time based on the aggregated projected demand data, and determining, based at least in part on the total projected demand, whether to scale up or scale down a capacity allocated to the microservice for the future period of time.

In an aspect, the method may include comparing the total projected demand for the microservice to a scale down threshold value, determining that the total projected demand is less than the scale down threshold value, and scaling down the capacity allocated to the microservice for the future period of time based on the determination that the total projected demand is less than the scale down threshold value.

In another aspect, the method may include comparing the total projected demand for the microservice to a scale up threshold value, determining that the total projected demand is greater than the scale up threshold value, and scaling up the capacity allocated to the microservice for the future period of time based on the determination that the total projected demand is less than the scale up threshold value.

In yet another aspect, the method may include identifying consumers of the microservice from which projected demand data has not been received, determining a historical usage of the microservice by the identified consumers, calculating a demand for capacity of the microservice for the future period of time based on the total projected demand and the historical usage of the microservice by the identified consumers, and determining a current capacity allocated to the microservice. In some aspects, determining whether to scale up or scale down the capacity allocated to the microservice for the future period of time may be based at least in part on the calculated demand for capacity of the microservice for the future period of time and the determined current capacity.

In an aspect, the method may include comparing the determined current capacity to the calculated demand for capacity, determining that the determined current capacity is less than the calculated demand for capacity of the microservice for the future period of time, and scaling up the capacity allocated to the micro service for the future period of time based on the determination that the determined current capacity is less than the calculated demand for capacity of the microservice for the future period of time.

In yet another aspect, the method may include comparing the determined current capacity to the calculated demand for capacity, determining that the determined current capacity is greater than the calculated demand for capacity of the microservice for the future period of time by a threshold amount, and scaling down the capacity allocated to the microservice for the future period of time based on the determination that the determined current capacity is greater than the calculated demand for capacity of the microservice for the future period of time by the threshold amount.

In aspects of the present disclosure apparatus, systems, and computer program products in accordance with the above aspect may also be provided. Any of the above aspects may be combined without departing from the scope of the present disclosure.

### BRIEF DESCRIPTION OF THE DRAWINGS

The details of the present disclosure, both as to its structure and operation, can best be understood by referring to the accompanying drawings, in which like reference numbers and designations refer to like elements.

FIG. 1 is a system diagram illustrating a system for auto scaling microservices based on projected demand data in accordance with an aspect of the present disclosure.

FIG. 2 is a flow chart of a method for auto scaling microservices based on projected demand data according to an embodiment of the present disclosure.

FIG. 3 is a flow chart of a method for publishing projected demand data according to an embodiment of the present disclosure.

FIG. 4 is a block diagram illustrated an example scenario for auto scaling microservices based on projected demand according to an embodiment of the present disclosure.

FIG. 5 is a flow chart of another method for auto scaling microservices based on projected demand data according to an embodiment of the present disclosure.

FIG. 6 is an exemplary block diagram of a computer system in which processes involved in the system, method, and computer program product described herein may be implemented.

FIG. 7 depicts a cloud computing environment according to an embodiment of the present invention.

FIG. 8 depicts abstraction model layers according to an embodiment of the present invention.

### DETAILED DESCRIPTION

The present disclosure provides methods and systems to provide automatic scaling of microservices based on projected demand. While the present disclose is discussed in the context of microservices, it is understood that the present disclosure may also or alternatively be applied to applications themselves or any other unit of software that may utilize the scaling of computing resources. In some systems, the microservices that make up an application are implemented such that as demand for a particular microservice increases, the resources allocated to that microservice are also increased. Likewise, as the demand for a particular microservice decreases, the resources allocated to that microservice also decrease. This system provides improved resource management and allows for better efficiencies on both the server side and the client side. For example, the client implementing the microservice only pays for the resources that are actually used and the server has the unused resources available for use by other microservices.

In some cases, the efficiencies of the above auto scaling system may be improved. For example, at the time that a surge in demand is detected, sufficient resources may not yet be allocated to the microservice. Because of this, there may be a slight delay in a consumer's use of the microservice while the additional resources are allocated to the microservice to meet the demand. The allocation of such resources in advance of the demand may provide for improved efficiency since the delay may be avoided.

In another example, a case may also arise where there is not enough resources available to meet the increased demand level. For example, if demand for a particular microservice is 1000 requests per second but it can only handle 500 requests per second based on the current resources that are available or allocated, the consumers using the high demand microservice may experience a slow-down or delay in their usage of the microservice. The consumers using the high demand microservice may then experience a slow-down or delay in their usage of the microservice. Such a slow-down or delay may cause consumer frustration and tarnish the reputation of the application or microservice. This case may arise, for example, when other microservices are also experiencing increased demand and have received a larger portion of the available resources. The allocation of such resources in advance of the demand may provide for improved efficiency since appropriate amount of resources may be allocated in advance, thereby avoiding a situation where insufficient resources are available to meet the rise in demand.

In some aspects, these efficiencies may be achieved according to the present disclosure by implementing a mechanism for determining and utilizing a projected demand level for a microservice during an auto scaling of resources to determine future resource allocations.

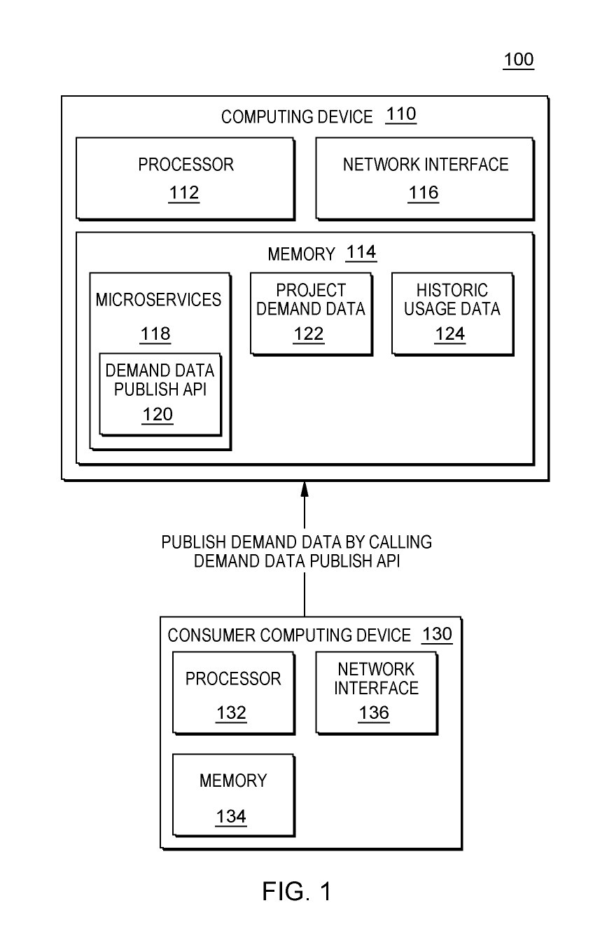

With reference now to FIG. 1, a system 100 for auto scaling microservices based on projected demand data is illustrated. In some aspects, system 100 includes a computing device 110, and a consumer computing device 130.

Computing device 110 includes at least one processor 112, memory 114, at least one network interface 116, and may include any other features commonly found in a computing device. In some aspects, computing device 110 may, for example, be any computing device that is configured manage or implement microservices 122. In some aspects, computing device 110 may include, for example, servers, web hosts, cloud computing devices, service provides, personal computers, laptops, tablets, smart devices, smart phones, smart watches, or any other similar computing device. In some aspects, computing device 110 is representative of a scalable computing system. For example, as demand increases, computing device 110 may add or re-allocate additional processors 112, memory 114, and network interfaces 116 as needed to meet the demand. In some aspects, the available resources may be limited, for example, by an available number of processors 112, network interfaces 116, bandwidth, memory 114, throughput, or in any other manner.

Processor 112 may include, for example, a microcontroller, Field Programmable Gate Array (FPGAs), or any other processor that is configured to perform various operations. Processor 112 may be configured to execute instructions as described below. These instructions may be stored, for example, in memory 114.

Memory 114 may include, for example, non-transitory computer readable media in the form of volatile memory, such as random access memory (RAM) and/or cache memory or others. Memory 114 may include, for example, other removable/non-removable, volatile/non-volatile storage media. By way of non-limiting examples only, memory 114 may include a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing.

In some aspects, memory 114 may store microservices 118 associated with one or more applications or computer programs that may be called by consumer computing device 130 and executed by processor 112 of computing device 110. For example, microservices 118 may be independently deployable services or components that may be called to perform a particular function. In some aspects, for example, each microservice 118 may run its own process and communicate with lightweight mechanisms, for example, as an HTTP resource API. In some aspects, for example, microservices 118 may be built around business capabilities and independently deployable by fully automated deployment machinery. For example, in some aspects microservices 118 may include a bare minimum of centralized management and may be written in different programming languages and use different data storage technologies. In some aspects, a microservice 118 may be called via API by one or more consumers. In some aspects, a microservice 118 may exist without an actual consumer where, for example, the microservice 118 may have no pending requests at a given time.

In some aspects, each individual microservice 118 may include a demand data publish application program interface (API) 120 that may be called by a consumer device 130 to publish to computing device 110 a projected usage demand for the individual microservice 118. For example, when the consumer computing device 130 calls the demand data publish API 120, the consumer computing device 130 may be requested to input a projected percentage, or other metric, of use over the next X minutes or other period of time. For example, the user may input a projected number of requests to the individual microservice 118 for a future period of time, e.g., the next X minutes, a projected percentage increase or decrease of calls to the individual microservice 118 for a future period of time, or any other data that provides a projection for the usage of the individual microservice 118. The projected usage may be transmitted or uploaded using the demand data publish API 120 to computing device 110 for storage in memory 114 as projected demand data 122.

In some aspects, the demand data publish API 120 may be called by a consumer computing device 130 for more than one microservice 118. For example, a generic demand data publish API 120 may be located in memory 114 independent of any individual microservice 118 and may be used to publish projected demand data 122 for any microservice 118 in memory 114 that may be called by consumer computing device 130 for execution by computing device 110. In some aspects, a single demand data publish API 120 call may be used to publish projected demand data 122 for more than one microservice 118.

In some aspects, memory 114 may also store historical usage data 124 for each microservice 118. The historical usage data 124 may include, for example, the average usage or calls of the microservice 118 per unit time, e.g., per minute, hour, day, week, month, quarter, year, or any other unit of time. In some aspects, historical usage data 124 may include, for example, usage data identifying peak usage times, days, etc. of the microservice 118. For example the historical usage data 124 may indicate which day of the week, which month of the year, which seasons, around which holidays, or other similar events microservice 118 has the most usage, least usage, or other similar metrics.

In some aspects, historical usage data 124 may include the usage data of microservice 118 broken down by each consumer. For example, historical usage data 124 may include historical usage data 124 for each consumer computing device 130. This historical usage data 124 may be utilized to set a baseline for expected usage by each consumer computing device 130 that has used the microservice 118 in the past. For example, if a particular consumer computing device 130 consistently calls a particular microservice 118 a certain number of times per hour, computing device 110 may pre-allocate resources to allow the consumer computing device 130 to use the microservice 118 the same number of times in the next hour.

Network interface 116 is configured to transmit and receive data or information to and from a consumer computing device 130 or any other computing device via wired or wireless connections. For example, network interface 116 may utilize wireless technologies and communication protocols such as Bluetooth®, WWI (e.g., 802.11a/b/g/n), cellular networks (e.g., CDMA, GSM, M2M, and 3G/4G/4G LTE), near-field communications systems, satellite communications, via a local area network (LAN), via a wide area network (WAN), or any other form of communication that allows computing device 110 to transmit or receive information to or from consumer computing device 130.

Consumer computing device 130 includes a processor 132, memory 134, and a network interface 136 that may include similar functionality as processor 112, memory 114, and network interface 116. In some aspects, consumer computing device 130 may, for example, be any computing device, server, or similar system that is configured to call or invoke one or more microservices 118 of computing device 110 for execution by computing device 110. Consumer computing device 130 may be configured to call the demand data publish API 120 and to transmit projected demand data 122 for a particular microservice 118 to computing device 110 using the demand data publish API 120. For example, consumer computing device 130 may call the demand data publish API 120 at any time once projected demand for use of a particular microservice 118 is known to consumer computing device 130. Projected demand data 122 may include, for example, a number of requests (and in some aspects, types of requests) expected to be made for an individual microservice 118 by the consumer for a defined unit of time, e.g., seconds, minutes, hours, days, etc., over a period of time, e.g., within the next minute, hour, day, week, etc., on a future day, or other period of time. In some aspects, projected demand data 122 may be determined, for example, automatically by the user. For example, the consumer may generate a historic data base of the customer's microservice usage for each microservice and then calculate a projected demand for the microservice that the consumer would like to reserve for future use.

Computing device 110 may automatically scale up or down the resource allocation for the particular microservice 118 based on the published projected demand data 122. For example, the demand data 138 may be determined and transmitted using a demand data publish application program interface (API) 140 stored in memory 134 of consumer computing device 130.

In some aspects, for example, a consumer computing device 130 may publish projected demand data 122 to computing device 110 for a particular period of time, X. For example, the period of time, X, may be the next 5 minutes, 10 minutes, 15 minutes, hour, half day, day, month, quarter, year, or any other unit of time. The projected demand data 122 may include a projected number of calls to microservice 118, a projected volume of usage of the capacity and resources associated with computing device 110 for microservice 118, or other similar metrics that may be used by computing device 110 to scale up or down the resources allocated to microservice 118 or resources allocated to consumer computing device 130 itself for the use of microservice 118 or any other microservices at computing device 110.

When computing device 110 receives the published projected demand data 122 for a microservice 118, computing device 110 may provide consumer computing device 130 with a minimum resource allocation guarantee to fulfill the projected demand for the microservice 118. In this manner, trusted consumers who are willing to publish projected demand data in a timely manner may received the benefit of guaranteed resource allocation over those customers who do not publish projected demand data.

In some aspects, computing device 110 may aggregate or accumulate all published projected demand data 122 for a particular microservice 118. For example, where more than one consumer computing device 130 publishes projected demand data 122 for the same microservice 118, the total or aggregate demand data may be accumulated by computing device 110 for determining whether to scale up or scale down resources for that microservice 118. For example, the number of projected calls may be added together to determine the total or aggregate demand data. In some aspects, for example, consumers may project usage amounts for different period of time. In this case, for example, the system may convert all projected usage amounts to a generic unit of time, and make demand determinations based on the aggregation of the converted amounts. For example, where a first consumer projects a certain demand for the next day and a second consumer projects a certain demand for the next 12 hours, the projected demand for the first consumer may be converted into a generic unit, e.g., hours. Then the portion of the projected demand of the first consumer corresponding to the next 12 hours may be aggregated with the projected demand of the second consumer, also the next 12 hours, to determine total projected demand for the next 12 hours. In some aspects, for example, where the period of time is the same but the units are different, e.g., one consumer publishes projected demand data per second for the next day while another consumer publishes projected demand data per minute for the next day, the units of the projected demand data of each consumer may be harmonized, e.g., to seconds or minutes, before aggregation for determining projected total demand.

In some aspects, if the accumulated or aggregated total projected demand crosses a pre-determine scale-up threshold, computing device 110 may automatically trigger a scaling up of resources for that microservice 118. Likewise, if the projected demand crosses a pre-determined scale-down threshold, computing device 110 may automatically trigger a scaling down of resources for that microservice. In some aspects, for example, the scale-up and scale-down thresholds may be determined by load testing of a microservice to determine a baseline and then determining the threshold values based on the determined baseline, e.g., as a percentage of the baseline. For example, once a baseline for a microservice has been determined, the scale-up and scale-down thresholds may be set as a percentage above or below the baseline, e.g., 15%, 20%, 25%, 50%, or any other percentage.

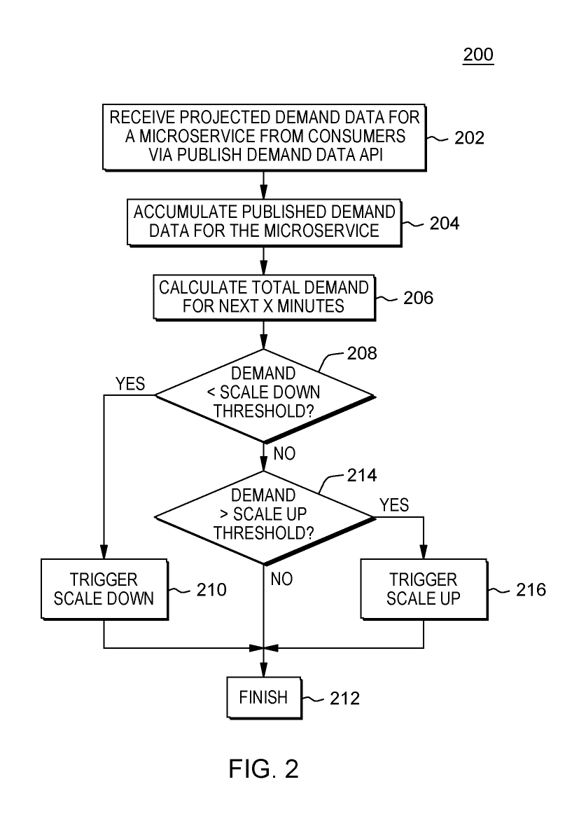

With reference now to FIG. 2, a method 200 for automatically triggering the scale up or scale down of resources allocated to a microservice 118 is illustrated.

At 202, computing device 110 receives projected demand data 122 for a microservice 118 from consumer computing device(s) 130 via demand data publish API 120.

At 204, computing device 110 accumulates or aggregates the published projected demand data 122 for microservice 118 received from each consumer computing device 130 and determines a total projected demand for the microservice 118 for the next period of time, e.g., X minutes, at 206. For example, the total projected demand for the next 15 minutes may be determined based on the aggregated or accumulated projected demand published by each consumer computing device 130 for the particular microservice 118.

At 208, computing device 110 determines whether the total projected demand is less than a SCALE DOWN threshold. For example, the SCALE DOWN threshold may be any metric or value, for example, a projected bandwidth requirement, number of calls to microservice 118, throughput, or any other metric that may be compared to the projected demand to determine whether the resources allocated to microservice 118 should be scaled down. If computing device 110 determines that the total projected demand, e.g., number of calls, projected bandwidth, etc., for the next period of time is less than the SCALE DOWN threshold, computing device 110 triggers a scale down of resources allocated to the particular microservice 118 at 210 and finishes at 212. For example, computing device 110 may reduce the processing, memory, or other computer resources allocated to microservice 118 based on the triggered scale down. If the total projected demand is greater than or equal to the SCALE DOWN threshold, method 200 proceeds to 214.

At 214, computing device 110 determines whether the total projected demand is greater than a SCALE UP threshold. For example, the SCALE UP threshold may be any metric or value, for example, a projected bandwidth requirement, number of calls to microservice 118, throughput, or any other metric that may be compared to the projected demand to determine whether the resources allocated to microservice 118 should be scaled up. If computing device 110 determines that the total projected demand is greater than the SCALE UP threshold, computing device 110 triggers a scale up of resources allocated to the particular microservice 118 at 216 and finishes at 212. For example, computing device 110 may increase the processing, memory, or other computer resources allocated to microservice 118 based on the triggered scale up. If the total projected demand is less than or equal to the SCALE UP threshold, the method proceeds to 212 and finishes.

In some aspects, the SCALE DOWN and SCALE UP thresholds may be set, for example, at default values, by a user of computing device 110, by a system administrator, or in any other manner such that the appropriate resources may be allocated by computing device 110 either to the particular microservice 118 or to other microservices as needed.

In some aspects, method 200 may be executed periodically by computing device 110 for each microservice 118 to update resource allocations to each microservice 118. For example, computing device 110 may execute method 200 every X minutes, e.g., 5 minutes, 15 minutes, or any other periodic amount of time. In some aspects, method 200 may be automatically executed by computing device 110 in response to receiving projected demand data 122 from a consumer computing device 130. For example, method 200 may be automatically executed every time projected demand data 122 is received from consumer computing device 130. In some aspects, method 200 may be automatically executed after a certain number of consumer computing device 130 have publishes projected demand data 122 for the microservice 118. In some aspects, computing device 110 may execute method 200 in response to any of the above conditions, separately or in combination.

In some aspects, the code associated with a microservice 118 or a microservice client executing on a consumer computing device 130 may be configured to calculate or determine projected demand data 122 for the microservice 118 or other microservices 118. In some aspects, the code may be configured to calculate a projected demand based, for example, past and current requirements to call a particular microservice 118. For example, where a first microservice includes a call to a second microservice, knowledge of that call to the first microservice in the code may be used to project future demand for the second microservice which may then be published to computing device 110 by consumer computing device 130 to scale up the resources allocated to the second microservice if necessary. Since a microservice is often combined with other associated microservices to perform the functions of a software application, projecting future demand for the other microservices associated with the software application may be accomplished by analyzing and calculating projected calls for the other microservices based on the calls for the current microservice. For example, if a first microservice includes a call to a second microservice, and the second microservice includes calls to third and fourth microservices, and so on, at the time that the consumer computing device 130 determines that the first microservice should be called, consumer computing device 130 may also publish projected demand data 122 to computing device 110 for when the second, third and fourth microservices are expected to also be called by consumer computing device 130. This provides system 100 with improved resource management and allocation in a forward looking manner.

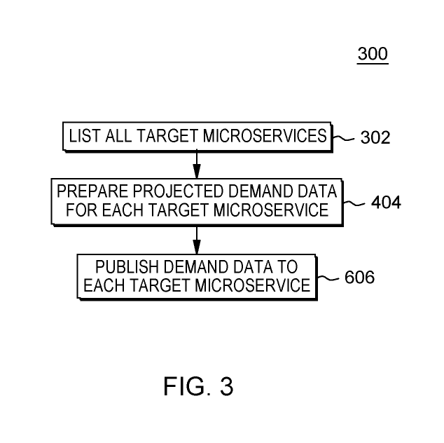

With reference now to FIG. 3, a method 300 for determining and publishing demand data is illustrated.

At 302, consumer computing device 130 determines a list of all target microservices to be executed.

In some aspects, for example, a user of consumer computing device 130 may activate a particular application, service, or other feature on consumer computing device 130 that results in calls to microservices 118 of computing device 110. In response to the user activation, the consumer computing device 130 may determine a list of target microservices, e.g., one or more initial microservices to be executed, and any other microservices that are associated with those microservices that may also need to be executed.

In some aspects, for example, when a consumer is preparing for a particular event or expects a particular load, e.g., holiday sales, seasonal event, sales week, or other similar activities that may result in an increase in demand, projected demand data may be determined based on pre-configured values. For example, the consumer may utilize historical demand information from prior sales to predict or project future demand data.

At 304, consumer computing device 130 prepares projected demand data 122 for each target microservice in the list of target microservices.

At 306, consumer computing device 130 publishes the projected demand data 122 for each target microservice using the demand data publish API 120 of computing device 110.

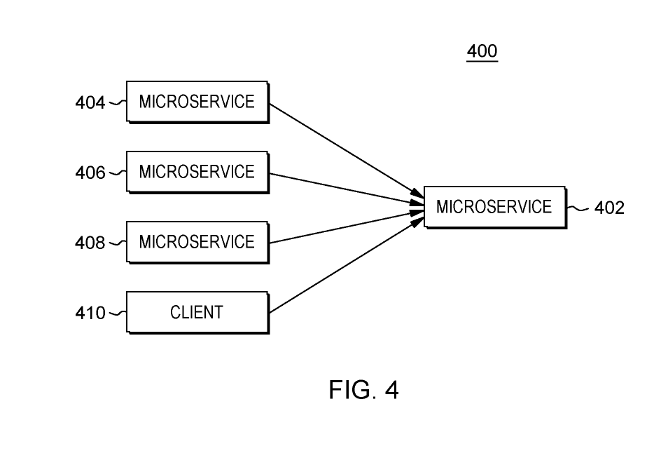

With reference now to FIG. 4, a single microservice 402 is called or consumed by each of microservices 404, 406, and 408, and directly by a client 410. For example, microservice 402 may execute an API that consumes a large amount of CPU processing power. Each of microservices 404, 406, and 408, and client 410, or the consumer computing devices 130 that call each of microservices 404, 406, 408 or client 410, may determine a projected demand for microservice 402 and may call the demand data publish API 120 to publish the projected demand for microservice 402 to computing device 110. For example, the projected demand data 122 may be a number of times that microservice 402 (or the API executed by microservice 402) will get called in a predetermined period of time, e.g., the next 30 minutes. In an example scenario, the SCALE DOWN threshold may be set as 1/30 minutes (one call every 30 minutes) and the SCALE UP threshold may be set as 100/30 minutes. If the accumulated or aggregated projected number of calls per 30 minutes from each of microservices 404, 406, 408 and client 410 is below the set SCALE DOWN threshold (less than one call) or above the set SCALE UP threshold (more than 100 calls), computing device 110 may scale up or scale down the resources allocated to microservice 402 for the next 30 minute period of time.

In some aspects, computing device 110 may provide a minimum guarantee of resource capacity for particular microservices 118 when consumer computing devices 130 publish projected demand data 122 for the particular microservices 118 in a timely manner. In some aspects, for example, the total capacity for a microservice may be set according to formula (1) below.

Total Capacity of a Micro Service at any time=(Capacity demanded by all consumers which published the demand+Capacity calculated on all consumers which did not publish based on historic usage+a default buffer capacity) (1)

For example, according to formula (1), the total capacity, e.g., resource demand, for a microservice 118 may include the aggregated or accumulated projected demand 122 published by consumers, expected demand calculated based on historic demand from consumers who did not publish projected demand data, and a pre-determined or user defined default buffer capacity that may be set at a level to ensure that small fluctuations in the expected demand can be accommodated.

In an example scenario, formula (1) may be utilized to determine a projected total capacity of resources to be allocated to a target microservice. In the example scenario, a first microservice may publish a projected demand of 500 calls per 30 minutes for the target microservice, a second microservice may publish a projected demand of 300 calls per 30 minutes for the target microservice, and a third microservice may not publish any projected demand data. The fourth microservice may have historically utilized 120 calls per 30 minutes for the target microservice. A default buffer capacity value may be set at, for example, 80 calls per 30 minutes. Applying formula (1), the total capacity of resources to be allocated to the target microservice is 500+300+120+80=1000 calls per 30 minutes.

Once the total capacity of resources to be allocated to the target microservice has been determined, the total demand capacity, e.g., 1000 calls per 30 minutes, may be compared to SCALE UP and SCALE DOWN thresholds. For example, if the target microservice currently has a capacity allocation to handle 2000 calls per 30 minutes but the total demand capacity as calculated above is 1000 calls per 30 minutes, this may be a scenario where the capacity is scaled down. For example, the SCALE DOWN threshold may be set such that the current capacity allocation, e.g., 2000 calls per 30 minutes, is greater than 150% of the calculated projected total capacity of 1000 calls per 30 minutes, e.g., 1500 calls per 30 minutes, the capacity allocation for the target microservice will be scaled down, e.g., to a value some % above the projected total capacity such as, for example, 125% of the projected total capacity. Likewise, if the current capacity allocation is 800 calls per 30 minutes, e.g., less than 100% of projected total capacity, the capacity allocation for the target microservice will be scaled up to accommodate the additional demand.

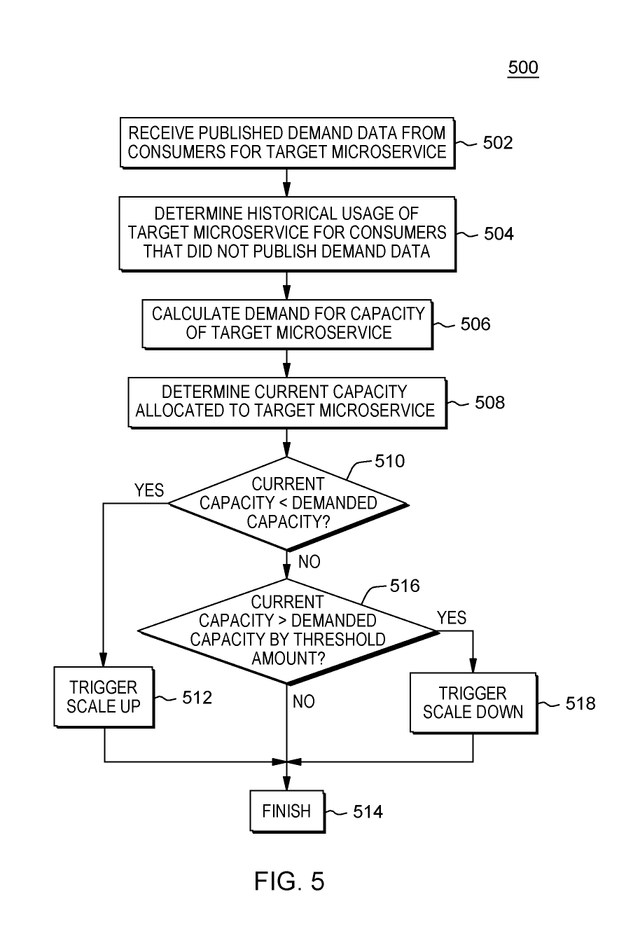

With reference now to FIG. 5, a method 500 for determining a scale up or scale down based on calculated total capacity is illustrated.

At 502, computing device 110 receives published demand data for a target microservice from consumer computing device 130.

At 504, computing device 110 determines historical usage of the target microservice for consumers that did not publish demand data.

At 506, computing device 110 calculates a demand for capacity of the target microservice, for example, using formula (1).

At 508, computing device 110 determines a current capacity allocated to the target microservice.

At 510, computing device 110 determines whether the current capacity is less than the demanded capacity. If the current capacity is less than the demanded capacity, method 500 proceeds to 512 and computing device 110 triggers a scale up of resources allocated to the target microservice. For example, computing device 110 may trigger a scale up of resources allocated to the target microservice to the demanded capacity. In some aspects, for example, computing device 110 may scale up the resources allocated to the target microservice to a % value above the demanded capacity, e.g., 125% of the demanded capacity. After the scale up is triggered, the method may finish at 514. If the current capacity is not less than the demanded capacity, the method proceeds to 516.

At 516, computing device 110 determines whether the current capacity is greater than the demanded capacity by a predetermined threshold amount, e.g., a % above the demanded capacity. In the scenario above, for example, computing device 110 may determine whether the current capacity is greater than 150% of the demanded capacity. If the current capacity is greater than the demanded capacity by the predetermined threshold amount, computing device 110 triggers a scale down of the current capacity at 518. For example, in some aspects, computing device 110 may scale down the current capacity to the demanded capacity. In some aspects, for example, computing device 110 may scale down the current capacity to some % value above the demanded capacity, e.g., 125% of the demanded capacity. After the scale down is triggered, the method may finish at 514. If the current capacity is not greater than the demanded capacity by the predetermined threshold amount, the method may also finish at 514 without a scale up or scale down occurring.

In some aspects, consumers of consumer computing devices 130 who do not publish projected demand data 122 for a target microservice may not receive guaranteed performance if their usage goes beyond the historical usage for that target microservice. For example, once the current capacity has been scaled up or scaled down based on the projected demand by other consumers for the target microservice and the historical usage data of consumers who did not publish projected demand data for the target microservice, as described above, any usage by the other consumers of the target microservice above the historical usage may require further real-time scale up of the resources allocated to the target microservice. Since this real-time scale-up may take some time as resources are re-allocated to the target microservice, the execution of the target microservice for the consumers who did not publish projected demand data may be delayed. In contrast, those who published projected demand data may be guaranteed the resources already allocated to them due to based on the projected demand. In the event that there is an insufficient amount of resources to allocated to the target microservice to fulfill the demand required by both the consumers that published projected demand data and the consumers that did not publish projected demand data, the consumers that published the projected demand data may be serviced first (at least for the projected demand amount) while the consumers that did not publish the projected demand data may be forced to wait while re-sources are either re-allocated or free up for the target service.

In some aspects, the projected demand data to be published may be determined based on a propagation of demands. For example, each microservice may form a link or node in a tree or map of microservices such that for each microservice that is called, projected demand for other associated or linked nodes may also be determined. For example, a hierarchy of demands for a tree or map of microservices may be determined by computing device 110 or consumer computing device 130. Each time a consumer computing device 130 publishes demand data for a first microservice, additional demand data may also be published for other microservices that are associated with the first microservice in the tree or map. For example, if the first microservice is a consumer of a second microservice and the second microservice is a consumer of a third microservice, when the projected demand data is published for the first microservice, projected demand data for the second and third microservices may also be generated and published based on the known links or associations between the first, second and third microservices defined in the tree or map.

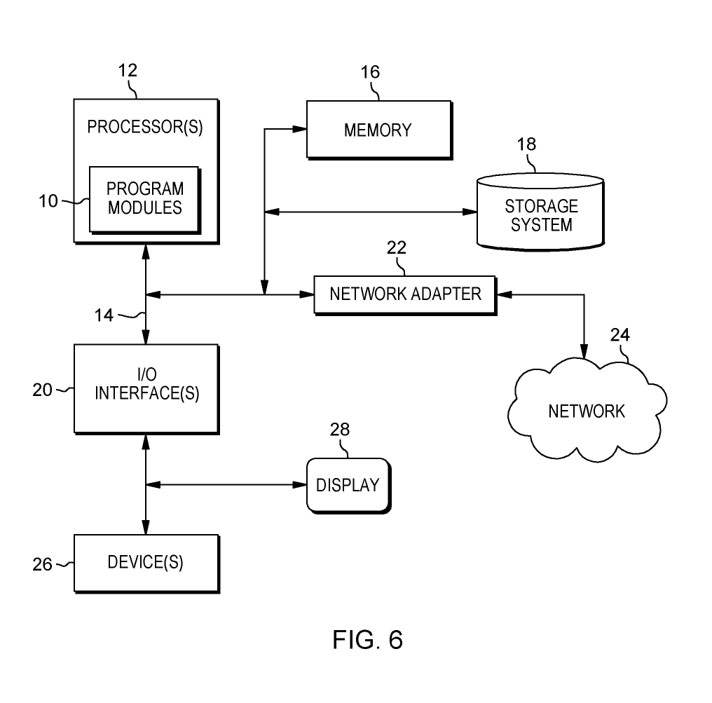

FIG. 6 illustrates a schematic of an example computer or processing system that may implement any portion of system 100, computing device 110, consumer computing device 130, systems, methods, and computer program products described herein in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a software module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

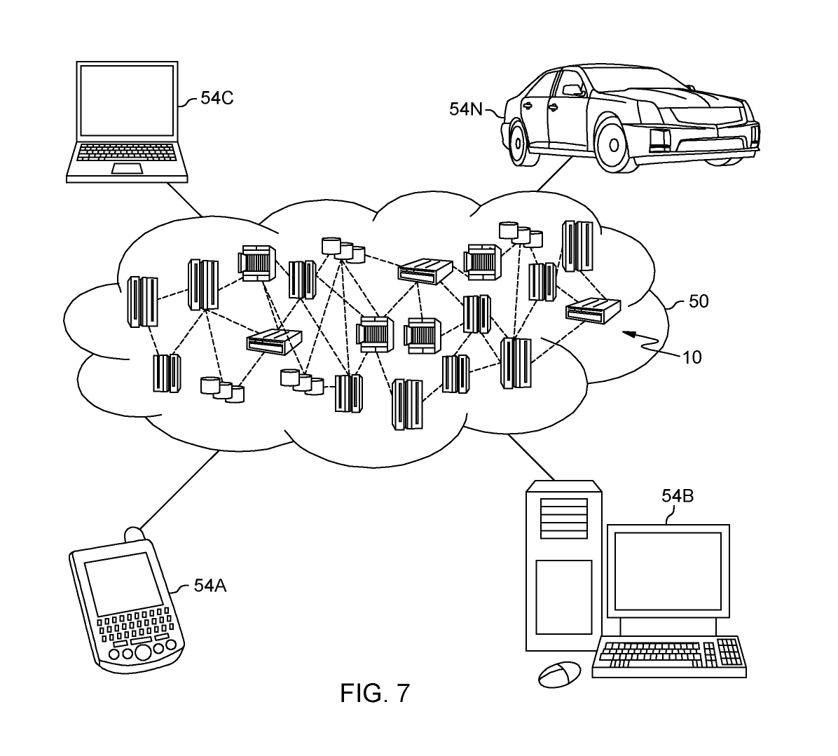

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

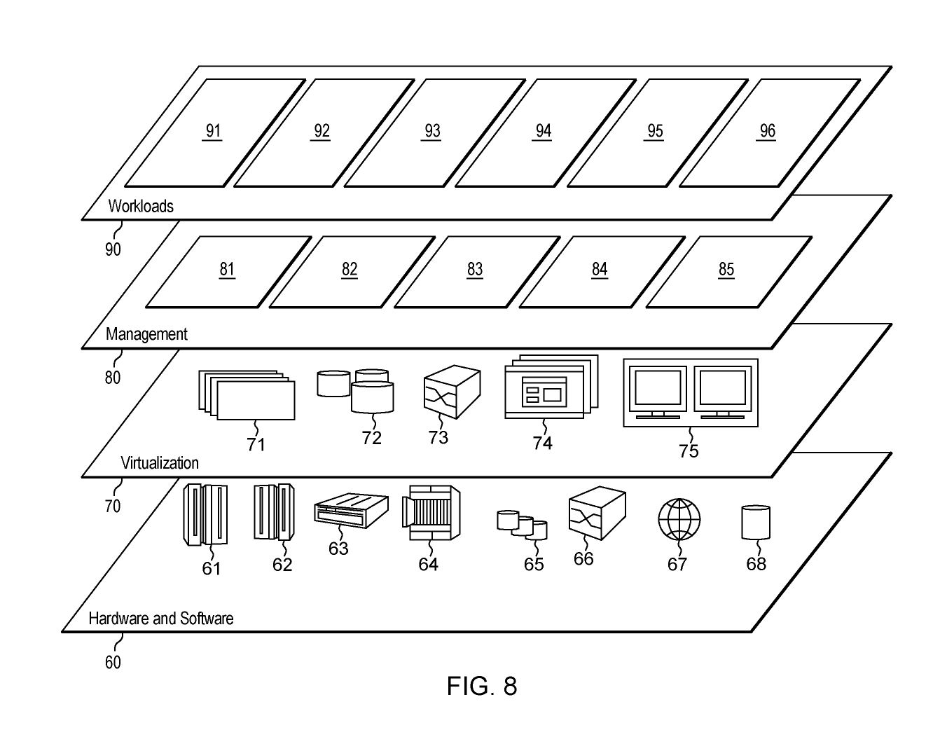

Referring now to FIG. 8, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and execution of microservices 96.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method implemented by at least one hardware processor for scaling up or down a capacity allocated to a microservice, the method comprising:
receiving projected demand data for a microservice from a plurality of consumers;
aggregating the projected demand data together;
calculating a total projected demand for the microservice for a future period of time based on the aggregated projected demand data; and
determining, based at least in part on the total projected demand, whether to scale up or scale down a capacity allocated to the microservice for the future period of time.

2. The method of claim 1, further comprising:
comparing the total projected demand for the microservice to a scale down threshold value;
determining that the total projected demand is less than the scale down threshold value; and
scaling down the capacity allocated to the microservice for the future period of time based on the determination that the total projected demand is less than the scale down threshold value.

3. The method of claim 1, further comprising:
comparing the total projected demand for the microservice to a scale up threshold value;
determining that the total projected demand is greater than the scale up threshold value; and
scaling up the capacity allocated to the microservice for the future period of time based on the determination that the total projected demand is less than the scale up threshold value.

4. The method of claim 1, further comprising:
determining that the microservice is a consumer of a second microservice;
generating projected demand data for the second microservice based on the projected demand data for the microservice; and
determining, based at least in part on the projected demand for the second microservice, whether to scale up or scale down a capacity allocated to the second microservice for a second future period of time.

5. The method of claim 1, further comprising:
identifying consumers of the microservice from which projected demand data has not been received;
determining a historical usage of the microservice by the identified consumers;
calculating a demand for capacity of the microservice for the future period of time based on the total projected demand and the historical usage of the microservice by the identified consumers; and
determining a current capacity allocated to the microservice,
wherein determining whether to scale up or scale down the capacity allocated to the microservice for the future period of time is based at least in part on the calculated demand for capacity of the microservice for the future period of time and the determined current capacity.

6. The method of claim 5, wherein calculating the demand for capacity of the microservice for the future period of time comprises adding the total projected demand, determined historical usage of the micro service by the identified customers, and a default buffer capacity together.

7. The method of claim 5, further comprising:
comparing the determined current capacity to the calculated demand for capacity;
determining that the determined current capacity is less than the calculated demand for capacity of the microservice for the future period of time; and
scaling up the capacity allocated to the microservice for the future period of time based on the determination that the determined current capacity is less than the calculated demand for capacity of the microservice for the future period of time.

8. The method of claim 5, further comprising:
comparing the determined current capacity to the calculated demand for capacity;
determining that the determined current capacity is greater than the calculated demand for capacity of the microservice for the future period of time by a threshold amount; and
scaling down the capacity allocated to the microservice for the future period of time based on the determination that the determined current capacity is greater than the calculated demand for capacity of the microservice for the future period of time by the threshold amount.

9. A system comprising at least one hardware processor configured to:
receive projected demand data for a microservice from a plurality of consumers;
aggregate the projected demand data together;
calculate a total projected demand for the microservice for a future period of time based on the aggregated projected demand data; and
determine, based at least in part on the total projected demand, whether to scale up or scale down a capacity allocated to the microservice for the future period of time.

10. The system of claim 9, the at least one hardware processor further configured to:
compare the total projected demand for the microservice to a scale down threshold value;
determine that the total projected demand is less than the scale down threshold value; and
scale down the capacity allocated to the microservice for the future period of time based on the determination that the total projected demand is less than the scale down threshold value.

11. The system of claim 9, the at least one hardware processor further configured to:
compare the total projected demand for the microservice to a scale up threshold value;
determine that the total projected demand is greater than the scale up threshold value; and
scale up the capacity allocated to the microservice for the future period of time based on the determination that the total projected demand is less than the scale up threshold value.

12. The system of claim 9, the at least one hardware processor further configured to:
determine that the microservice is a consumer of a second microservice;
generate projected demand data for the second microservice based on the projected demand data for the microservice; and
determine, based at least in part on the projected demand for the second microservice, whether to scale up or scale down a capacity allocated to the second microservice for a second future period of time.

13. The system of claim 9, the at least one hardware processor further configured to:
identify consumers of the microservice from which projected demand data has not been received;
determine a historical usage of the microservice by the identified consumers;
calculate a demand for capacity of the microservice for the future period of time based on the total projected demand and the historical usage of the microservice by the identified consumers; and
determine a current capacity allocated to the microservice,
wherein determining whether to scale up or scale down the capacity allocated to the microservice for the future period of time is based at least in part on the calculated demand for capacity of the microservice for the future period of time and the determined current capacity.

14. The system of claim 13, wherein calculating the demand for capacity of the microservice for the future period of time comprises adding the total projected demand, determined historical usage of the microservice by the identified customers, and a default buffer capacity together.

15. The system of claim 13, the at least one hardware processor further configured to:
compare the determined current capacity to the calculated demand for capacity;
determine that the determined current capacity is less than the calculated demand for capacity of the microservice for the future period of time; and
scale up the capacity allocated to the microservice for the future period of time based on the determination that the determined current capacity is less than the calculated demand for capacity of the microservice for the future period of time.

16. The system of claim 13, the at least one hardware processor further configured to:
compare the determined current capacity to the calculated demand for capacity;
determine that the determined current capacity is greater than the calculated demand for capacity of the microservice for the future period of time by a threshold amount; and
scale down the capacity allocated to the microservice for the future period of time based on the determination that the determined current capacity is greater than the calculated demand for capacity of the microservice for the future period of time by the threshold amount.

17. A non-transitory computer readable medium comprising instructions that, when executed by at least one hardware processor, configure the at least one hardware processor to:
receive projected demand data for a microservice from a plurality of consumers;
aggregate the projected demand data together;
calculate a total projected demand for the microservice for a future period of time based on the aggregated projected demand data; and
determine, based at least in part on the total projected demand, whether to scale up or scale down a capacity allocated to the microservice for the future period of time.

18. The non-transitory computer readable medium of claim 17, the instructions further configuring the at least one hardware processor to:
compare the total projected demand for the microservice to a scale down threshold value;
determine that the total projected demand is less than the scale down threshold value; and
scale down the capacity allocated to the microservice for the future period of time based on the determination that the total projected demand is less than the scale down threshold value.

19. The non-transitory computer readable medium of claim 17, the instructions further configuring the at least one hardware processor to:
compare the total projected demand for the microservice to a scale up threshold value;
determine that the total projected demand is greater than the scale up threshold value; and
scale up the capacity allocated to the microservice for the future period of time based on the determination that the total projected demand is less than the scale up threshold value.

20. The non-transitory computer readable medium of claim 17, the at least one hardware processor further configured to:
identify consumers of the microservice from which projected demand data has not been received;
determine a historical usage of the microservice by the identified consumers;
calculate a demand for capacity of the microservice for the future period of time based on the total projected demand and the historical usage of the microservice by the identified consumers; and
determine a current capacity allocated to the microservice,
wherein determining whether to scale up or scale down the capacity allocated to the microservice for the future period of time is based at least in part on the calculated demand for capacity of the microservice for the future period of time and the determined current capacity.
